(19) United States
(12) Patent Application Publication
(10) Pub. No.: US 2009/0053045 A1
(43) Pub. Date: Feb. 26, 2009

(54) Turbine Shroud for Gas Turbine Assemblies and Processes for Forming the Shroud

(75) Inventors: Daniel Nowak, Greensville, SC (US); Poornathresan Krishnakumar, Greer, SC (US); Richard L. Zhao, Chicago, IL (US); Melbourne James Myers, Duncan, SC (US); Christopher Hans Trangsrud, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/843,346

(22) Filed: Aug. 22, 2007

(51) Int. Cl. F02C 7/28; B23P 15/00

(52) U.S. Cl. 415/173.1; 415/173.6; 29/888.3

(57) ABSTRACT

A gas turbine assembly includes a shroud that includes a plurality of interconnected shroud segments, wherein each one of the shroud segments comprises an arcuate base formed of a first metal material. The arcuate base is made up of an annular member having an axial component and a pair of upstanding ribs having flanges, wherein the arcuate base further comprises a high temperature capable material layer disposed on a surface of the arcuate base so as to define an inner diameter of the shroud segment (i.e., the hot gas path side or environmental side).

### BACKGROUND

The present disclosure relates to gas turbine shrouds, and more particularly, to multi-metal material gas turbine shrouds having a second metal material applied to an inner diameter of the shroud (i.e., the hot gas path side) and a first metal material forming the remainder of the shroud. The second metal is selected to provide high temperature capability relative to the first metal material. Processes for forming the shroud are also disclosed.

Typically in a gas turbine engine, a plurality of stationary shroud segments are assembled circumferentially about an axial flow engine axis and radially outwardly about rotating blading members, e.g., turbine blades, to define a part of the radial outer flow path boundary over the blades. In addition, the assembly of shroud segments is assembled in an engine axially between such axially adjacent engine members as nozzles and/or engine frames. The stationary shroud confines the combustion gases to the gas flow path so that the combustion gas is utilized with maximum efficiency to turn the gas turbine. Operating temperature of this flow path can be greater than 500° C. The shroud, which includes a surface defining an inner diameter, is exposed the hot flow gas path.

Current practice is to fabricate the entire shroud from a single metal material, e.g., a high temperature capable superalloy or high temperature capable stainless steel. Although this is generally considered the most practical and less complex solution, the use of the high temperature capable materials are not cost effective since the entire shroud is formed of the material. Other solutions include coating a thermal barrier layer onto the surface of the shroud, which also adds significant costs to the shroud. More complex designs include increasing the cooling of the shroud. However, cooling the shroud directly and negatively impacts turbine efficiency. Still other proposed solutions include the use of two-piece shrouds that are mechanically attached to one another. However, as one would expect, the use of two pieces can decrease turbine efficiency as well as cost as the shrouds will use more cooling air and increase the number of parts.

Accordingly, there remains a need in the art for improvements to the shrouds that will be cost effective, provide maximum turbine efficiency, and can be easily integrated with current designs.

### SUMMARY OF THE INVENTION

Disclosed herein are shroud assemblies for a gas turbine and processes for manufacturing the shroud assembly. In one embodiment, a gas turbine comprises a shroud comprising a plurality of interconnected shroud segments, wherein each one of the shroud segments comprises an arcuate base formed of a first metal material and made up of an annular member having an axial component and a pair of upstanding ribs and having flanges, wherein the arcuate base further comprises a second metal material bonded to the first metal material of the arcuate base so as to define an inner diameter of the shroud segment.

In another embodiment, a gas turbine comprises a shroud comprising a plurality of interconnected shroud segments, wherein each one of the shroud segments comprises an arcuate base formed of a first metal material stable at a temperature less than 800° C. and made up of an annular member having an axial component and a pair of upstanding ribs and having flanges; and a second metal material bonded to the first metal material so as to define an inner diameter of the shroud segment, wherein the second metal material is stable at temperatures greater than 600° C.

A process for manufacturing a shroud for a turbine engine comprises forming a ring having a pair of upstanding ribs and having flanges wherein the ring is formed of a first metal material; and bonding a second metal material to a surface of the ring defining an inner diameter.

The above described and other features are exemplified by the following detailed description and appended claims.

### BRIEF DESCRIPTION OF THE DRAWINGS

Referring now to the figures wherein the like elements are numbered alike:

FIG. 1 is a cross sectional view of an exemplary shroud segment in accordance with an embodiment of the present disclosure; and

FIG. 2 is a perspective view of the shroud segment.

### DETAILED DESCRIPTION

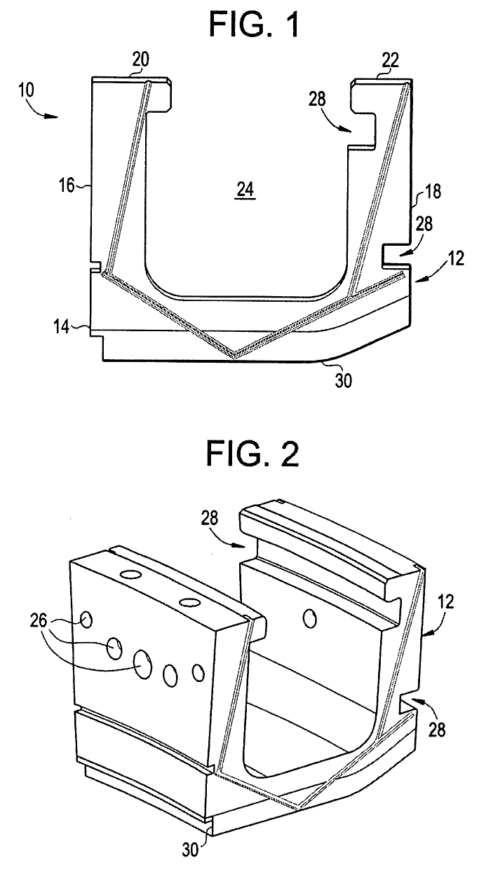

Referring now to FIGS. 1 and 2, there is shown a shroud segment 10 of a shroud for use in a gas turbine. A plurality of the segments 10 define the shroud and are arranged circumferentially and concentric with a rotor on which the turbine blades are mounted. Generally, the shroud is produced in a ring, segmented, and then provided for end use application as a set. The present disclosure is not intended to be limited to the particular shroud segment shown.

Each shroud segment 10 generally includes an arcuate base 12 made up of an annular flat plate-like member 14 having an axial component and a pair of upstanding ribs 16 and 18 having flanges 20 and 22, respectively. The arcuate base 12 is formed of a first metal material. The ribs 16, 18 and respective flanges 20, 22 act to support the shroud base 12 as well as to define cooling passages and chambers, e.g., chamber 24. The flanges 20, 22 also serve to mount the shroud segments within the engine casing and mounting structure. Additional cooling passages 26 may be disposed in the ribs 16, 18 as well as notches 28 for support may be included as is shown more clearly in FIG. 2.

A second metal material 30 defining an inner diameter of the shroud segment 10 is integrally attached (i.e., bonded) to a surface of the annular flat plate-like member 14 and in one embodiment, is formed of a high temperature capable material, i.e., stable at temperatures greater than 600° C. In contrast, the arcuate base 12 is formed from a lower temperature capable material, i.e., unstable at temperatures greater than about 800° C. In this manner, the shroud segment, which is typically exposed to the hot gas flow path during operation of the gas turbine, can withstand the temperatures used during turbine operation by the presence of the second metal material 30 yet provide a reduction in the amounts of high temperature capable material used to fabricate the shroud. The first metal material, i.e., the lower temperature capable material, which is generally less expensive than the higher temperature capable material, can be used without sacrificing the utility and operating lifetime of the shroud. This represents a significant commercial advantage.

In one embodiment, the first metal material is selected to be stable at temperatures greater than 600° C. and the second metal material is selected to be stable temperatures less than 800° C. In other embodiments, the second metal material is selected to have a higher melting temperature than the first metal material. Generally, it has been found that the higher stability material is more expensive than the lower temperature stability material.

Suitable second metal materials are those high temperature capable materials that can withstand the elevated temperatures provided by the hot gas flow path of operation in a gas turbine engine. Exemplary materials include, but are not limited to, superalloys. Suitable superalloys are typically a nickel-based, iron-based, or a cobalt-based alloy, wherein the amount of nickel, iron, or cobalt in the superalloy is the single greatest element by weight. Illustrative nickel-based superalloys include at least nickel (Ni), and at least one component from the group consisting of cobalt (Co), chromium (Cr), aluminum (Al), tungsten (W), molybdenum (Mo), titanium (Ti), tantalum (Ta), zirconium (Zr), niobium (Nb), rhenium (Re), carbon (C), boron (B), hafnium (Hf), and iron (Fe). Examples of nickel-based superalloys are designated by the trade names Haynes®, Hasteloy®, Incoloy®, Inconel®, Nimonic®, Rene® (e.g., Rene®80, Rene®95, Rene®142, and Rene®N5 alloys), and Udimet®, and include directionally solidified and single crystal superalloys. Illustrative cobalt-base superalloys include Co, and at least one component from the group consisting of Ni, Cr, Al, W, Mo, Ti, and Fe. Examples of cobalt-based superalloys are designated by the trade names Haynes®, Nozzaloy®, Stellite® and Ultimet® materials. Illustrative iron-base superalloys include Fe, and at least one component from the group consisting of Ni, Co, Cr, Al, W, Mo, Ti, and manganese (Mn). Examples of iron based superalloys are designated by the trade names Haynes®, Incoloy®, Nitronic® Other suitable materials for forming the second metal material include Haynes® HR-120™ alloy, Haynes® 556™ alloy, Haynes® 230® alloy, Haynes® 188® alloy, Hastelloy® X alloy, or Inconel® 738 M alloy.

Suitable materials for forming the arcuate base 12 include stainless steels such as AISI 304 stainless steel, 310 stainless steel, AISI 347 stainless steel, AISI 410 stainless steel, or superalloys such as Haynes® HR-120® alloy. Other suitable materials for forming the high temperature layer i.e., the environmental side, include Haynes® HR-120™ alloy, Haynes® 556™ alloy, Haynes® 230® alloy, Haynes® 188® alloy, Hastelloy® X alloy, or Inconel® 738™ alloy.

A suitable thickness of the base 12 will vary depending on the particular application and stage. For example, the first metal material can be from about 1 inch to about 12 inches in thickness depending on where the thickness is measured whereas the second metal material formed on the hot path gas side (i.e., the environmental side) can be less than about 2 inches in thickness in some embodiments, about 1 inch in thickness in other embodiments and less than about 0.75 inches in thickness in still other embodiments.

In manufacturing the shroud segments, a shroud ring is first formed by forging a ring or an individual ring segment of the first metal material such as by closed forging, seamless ring forging, variations thereof, and the like. Alternatively, the shroud ring or shroud segments can be formed by sand casting, investment casting, centrifugal casting, fabricated, and the like. The particular method for forming the shroud ring is not intended to be limited. Once the ring is formed, the second metal material is fixedly attached to the inner diameter of the ring. Attachment of the high temperature capable material can be by any means and includes such techniques as weld build up, strip cladding, brazing, solid state bonding, and the like. The second metal is integral to the first metal material. Once attached, the ring is cut into segments and provided to the end user as a set.

The following examples are provided to further illustrate the present process and are not intended to limit the scope hereof.

### EXAMPLES

In this example, a ring was forged from AISI 310 stainless steel (i.e., the first metal material) to which a layer of Haynes® 556® (i.e., the second metal material) was deposited by a weld build up process on the inner diameter of the forged ring. The ring diameters were finally turned and the ring was cut into segments on a band saw.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gas turbine comprising:
a shroud comprising a plurality of interconnected shroud segments, wherein each one of the shroud segments comprises an arcuate base formed of a first metal material and made up of an annular member having an axial component and a pair of upstanding ribs and having flanges, wherein the arcuate base further comprises a second metal material bonded to the first metal material of the arcuate base so as to define an inner diameter of the shroud segment.

2. The gas turbine of claim 1, wherein the second metal material is selected to be stable at temperatures greater than 600° C. and the first metal material is stable at temperatures less than 800° C.

3. The gas turbine of claim 1, wherein the second metal material is a superalloy.

4. The gas turbine of claim 1, wherein the first metal material is formed of a stainless steel.

5. The gas turbine of claim 1, wherein the second metal material has a higher melting point than the first metal material.

6. The gas turbine of claim 1, wherein the second metal material is at a thickness of less than about 2 inches and the first metal material is at a thickness from about 1 inch to about 12 inches.

7. The gas turbine of claim 1, wherein the second metal material is at a thickness less than about 1 inch and the first metal material is at a thickness of about 1 inch to about 12 inches.

8. The gas turbine of claim 1, wherein the second metal material has a thickness less than about 0.75 inches and the first metal material is at a thickness of about 1 inch to about 12 inches.

9. A process for manufacturing a shroud for a turbine engine, comprising:
forming a ring having a pair of upstanding ribs and having flanges, wherein the ring is formed of a first metal material; and bonding a second metal material to a surface of the ring defining an inner diameter.

10. The process of claim 9, wherein the second metal material is selected to be stable at temperatures greater than 600° C. and the first metal material is stable at temperatures less than 800° C.

11. The process of claim 9, further comprising segmenting the ring into segments.

12. The process of claim 9, wherein bonding the second metal material to the first metal material comprises a weld build-up process, a strip cladding process, a brazing process or a solid state bonding process.

13. The process of claim 9, wherein forming the ring comprises a forging process, sand casting, investment casting, centrifugal casting, and a fabrication process.

14. The process of claim 9, wherein the second metal material is selected to have a higher melting point than the first metal material.

15. A gas turbine comprising:
a shroud comprising a plurality of interconnected shroud segments, wherein each one of the shroud segments comprises an arcuate base formed of a first metal material stable at a temperature less than 800° C. and made up of an annular member having an axial component and a pair of upstanding ribs and having flanges; and a second metal material bonded to the first metal material so as to define an inner diameter of the shroud segment, wherein the second metal material is stable at temperatures greater than 600° C.

16. The gas turbine of claim 15, wherein the second metal material is a superalloy.

17. The gas turbine of claim 15, wherein the first metal is formed of a stainless steel.

18. The gas turbine of claim 15, wherein the layer of the second metal material is at a thickness less than about 2 inches and the first metal material is at a thickness from about 1 inch to about 12 inches.

19. The gas turbine of claim 15, wherein the second material is selected to have a higher melting point than the first metal material.

20. The gas turbine of claim 15, wherein the second metal material has a thickness less than about 0.75 inches and the first metal material is at a thickness of about 1 inch to about 12 inches.
